(19) United States
(12) Patent Application Publication
(10) Pub. No.: US 2006/0289422 A1
(43) Pub. Date: Dec. 28, 2006

(54) Electric circuit for wiring a heating element

(76) Inventor: Michael Seifert, Augsburg (DE)

Correspondence Address: Robert P. Renke, Suite 250, 28333 Telegraph Road, Southfield, MI, 48034, US

(21) Appl. No.: 11/474,184

(22) Filed: Jun. 23, 2006

(30) Foreign Application Priority Data
Jun. 23, 2005 (DE) DE102005029 180.5

(51) Int. Cl. H05B 1/00

(52) U.S. Cl. 219/217

(57) ABSTRACT

An electric circuit for wiring at least one heating element has a first and a second selector switch (2, 3), which has a neutral position (3a) and at least one non-fixable switching position (3b, 3c), a relay (4), which has a relay-actuated contact (5) that is open when the relay (4) is disconnected from the supply voltage and which is closed when the relay (4) is acted on by the supply voltage, and a thermal switch (9) which is in contact with the heating element (7) and opens when a predetermined temperature has been reached, where the relay (4) and the thermal switch (9) are connected in series. When the contact (5) is closed, the heating element (7) is acted on by the supply voltage. Setting the selector switch (2, 3) to the first non-fixable switching position (3b) causes the relay (4) to change the switching status of the contact (5) from open to closed or vice versa.

### TECHNICAL FIELD

The invention relates to an electric circuit for wiring at least one heating element having a supply voltage from a voltage source.

### BACKGROUND OF THE INVENTION

For turning electric heating elements on and off, as well as for operating them, temperature-controlled heating systems in which electronic devices, such as for example a control having a temperature-sensitive element, that monitor the temperature of the system and, if necessary, turn the heat either on or off, are used at the present time. Such systems are often used in vehicle seat-heating systems. In systems of this kind, high production costs and susceptibility to defects due to the use of complicated electronic circuits are disadvantageous.

Also known are thermostat-controlled heating systems in which a temperature-sensitive switch used in the thermostat turns the flow of heat on and off directly. Such systems are less costly, but they only operate with locking switches, i.e., switches capable of being fixed in switched-on position. There the problem arises that the turned-on heating system remains in this state of operation even when the heat is no longer needed. Also, turning off the ignition in a motor vehicle does not cause the system to switch off, so that the next time the ignition in the motor vehicle is activated, the heating system is necessarily turned on again.

### SUMMARY OF THE INVENTION

The present invention is directed toward an electric circuit for wiring at least one heating element, whose production costs are reduced in comparison with existing electronic control devices, while operating reliability is increased.

The electric circuit according to the invention has the following elements: a voltage source delivering a supply voltage, at least one heating element, at least one selector switch, which has at least one neutral position and one non-fixable switching position, at least one relay with a relay-actuated contact that is open when the relay is disconnected from the supply voltage and is closed when the relay is acted on by the supply voltage, while when the contact is closed the heating element is acted on by the supply voltage, as well as a thermal switch that is in contact with the heating element and opens when a predetermined temperature is reached. The relay and the thermal switch are connected in series, whereby setting the selector switch to the first non-fixable switching position causes the relay to change the switching status of the contact from open to closed or vice versa.

It is thereby ensured that, even with minimal manufacturing costs for the electric circuit, the heating is acted on by the supply voltage only up to a predetermined temperature and then is automatically turned off.

An additional advantage of the invention is that after the vehicle ignition is turned off, the heating system is also turned off, so that it can only be reactivated by actuation of the selector switch. This results in high reliability of the electric circuit according to the invention, since heating inadvertently left on after the supply voltage in the motor vehicle is turned off is automatically shifted into a turned-off state.

Such an electric circuit further permits the selector switch as well as the thermal switch to be made smaller in size, since there is no flow of heat through these elements.

In another example, the relay is a single-pole relay, and when the contact is closed, the relay is acted on by the supply voltage, in the first switching position of the selector switch the relay is acted on by the supply voltage, and in the second switching position of the selector switch the relay is disconnected from the supply voltage in order to open the switching status of the contact. In another aspect of the invention, the relay is a double-pole relay.

According to another embodiment, the voltage source, in the second switching position of the selector switch, can be short-circuited by a first resistance. The voltage source can be a direct-current voltage source that has a first pole and a second pole, the relay can have an input and an output, the heating elements, which are connected in series, can have a first and a second connection, where the first connection, via the contact, is connected to the first pole of the direct-current voltage source and the second connection is connected to the second pole of the direct-current voltage source. The thermal switch can be connected between the output of the relay and the second pole of the direct-current voltage source, where in the first switching position of the selector switch the input of the relay is electrically connected with the first pole of the direct-current voltage source, and in the second switching position of the selector switch the input of the relay is electrically connected with the second pole of the direct-current voltage source and where the first connection of the heating elements is electrically connected with the input of the relay. In a further aspect, a diode can be connected between the input of the relay and the first connection of the heating elements, owing to which, in the first switching position of the selector switch, a voltage is obtained in the direction of the heating elements. The input of the relay can also be connected by a light-emitting diode to the second pole of the direct-current voltage source. In any of these embodiments, the selector switch can be an automatic resetting selector switch.

In another aspect of the invention, a second thermal switch is provided, where the first thermal switch is associated with a first heating element and the second thermal switch is associated with a second heating element, and where the first and the second thermal switches can switch at different temperatures. The second thermal switch can have at least one first switching position in which the first flow of heat travels through the two heating elements connected in series, and at least one second switching position in which substantially all of the potential of the supply voltage is applied to the second heating element. In a further aspect, the second thermal switch can be connected in parallel with the first heating element, where in its first switching position it is open and in its second switching position it is closed.

In still a further embodiment of the invention, the relay has an input, output, first connection and second connection. The input (IN) feeds the supply voltage from a first pole of a voltage source. The first connection (set/reset) connects with the selector switch, whose switching into a non-fixable switching position causes change of the switching status of the contact located in the relay. The output (OUT) acts on the heating elements by the supply voltage. Finally, the second connection (GND) is connected by the at least one thermal switch to a second pole of the voltage source.

Other advantages will become apparent with reference to the following detailed description, taken in conjunction with the accompanying drawings.

### BRIEF DESCRIPTION OF THE DRAWINGS

In the following, the invention is described in detail with reference to the accompanying drawings, wherein:

FIG. 1 shows the electric circuit according to the invention with a single-pole relay.

FIG. 2 shows the electric circuit according to the invention with a double-pole relay.

FIG. 3 shows the electric circuit as in FIG. 1, but with two thermal switches.

FIG. 4 shows a perspective and block diagrammatic view of a vehicle seat incorporating an electric circuit according to an embodiment of the present invention.

### DETAILED DESCRIPTION OF THE INVENTION

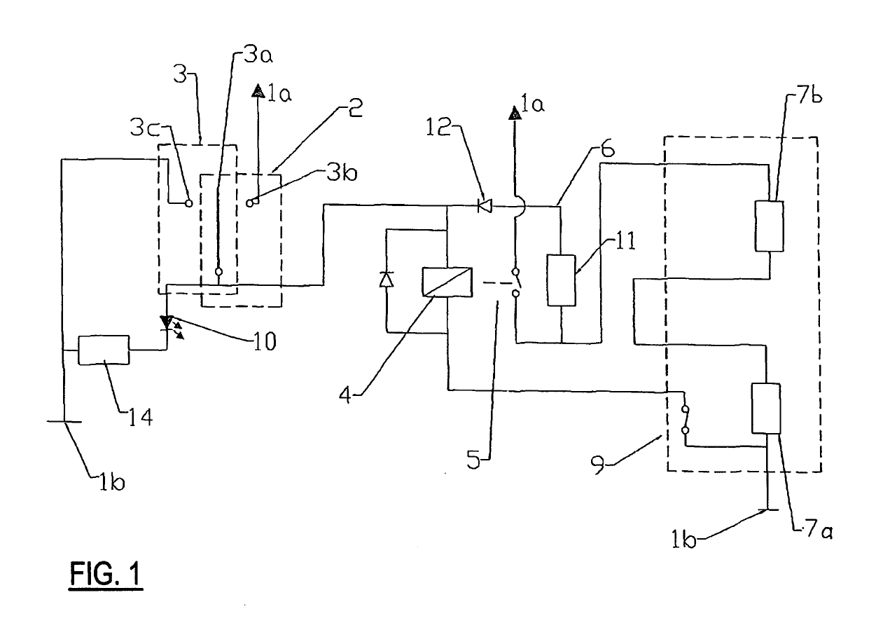

In the exemplary embodiment illustrated in FIG. 1, an electric circuit contains two heating elements 7a, 7b connected in series, and a selector switch 2, 3, which has a neutral position 3a, a first non-fixable switching position 3b and a second non-fixable switching position 3c. The selector switch 2, 3 may alternatively comprise two individual switches, which are indicated in the figure by broken lines, such a switch containing a first automatic resetting selector switch 2 whose two contacts 3a and 3b in a neutral position are open and in a non-fixable position contact each other, and a second automatic resetting selector switch 3, which is formed by two contacts 3c and 3d, where in a neutral position of the second selector switch 3 the contacts 3c and 3d are open, while in a non-fixable switching position both contacts are closed. The two selector switches 2 and 3 are integrated into one selector switch so that switching by an automatic resetting movable contact takes place, while the contact may occupy a neutral position 3a, a first non-fixable position 3b and a second non-fixable position 3c.

The electric circuit according to the invention further has a single-pole relay 4, which has a relay-actuated contact 5 that is open when the relay 4 is disconnected from the supply voltage and which is closed when the relay 4 is acted on by the supply voltage. The relay 4 is connected in such a way that when the contact 5 is closed, the heating elements 7a, 7b and the relay 4 are acted on by the supply voltage from the first pole 1a.

Connected in series with the relay 4 is a thermal switch 9, which is in thermal contact with the heating element 7b. In an original state, that is, in a state at ambient temperature, the thermal switch 9 is closed, so that when the selector switch 2, 3 is closed in its first position 3b, current flows through the winding of the relay 4 and through the thermal switch 9. The heating elements 7a, 7b, connected in series, are connected in parallel with the relay 4 and with the thermal switch 9. Still additional heating elements may be provided in parallel or in series with the heating elements 7a, 7b. A diode 12 is connected between the input of the relay 4 and the heating element 7a so that, in the first position 3b of the selector switch, closing in the direction of the heating element 7a is obtained. Connected in series with the diode 12 is a first resistance 11, which in turn is connected via the relay-actuated contact 5 with a first pole 1a of a direct-current voltage source.

Parallel to the relay 4 and the thermal switch 9, a light-emitting diode 10 and a second resistance 14 are connected in series.

Operation of the circuit arrangement represented in FIG. 1 proceeds as follows.

In the first switching position 3b of the selector switch, as already mentioned above, current flows through the relay 4 and through the thermal switch 9. There the diode 12, in the first position 3b of the selector switch, prevents the current from also flowing through the heating elements 7a, 7b. The relay 4, acted on by the supply voltage, then closes the contact 5, which likewise is connected to the first pole 1a of the direct-current voltage source. The current thus flows through the heating elements 7 and through the first resistance 11 connected in parallel thereto, the diode 12, the relay 4 and the thermal switch 9. Further, the current also flows through the second resistance 14 and through the light-emitting diode 10, whereby the turned-on state of the electric circuit is made known visually.

Now, if the thermal switch 9, as a result of heating by the heating element 7a, reaches a predetermined temperature, it switches into an open state, so that the flow of current through the relay 4 is interrupted. Because of the resetting force of the relay-actuated contact 5, the latter is disconnected, owing to which it interrupts the voltage supply of the heating elements 7. The electric circuit is thereby an open circuit.

Another possibility for breaking the circuit may be obtained by switching the selector switch 2, 3 into its second position 3c, whereupon the voltage source is short-circuited via the first resistance 11 and via the diode 12. This causes a voltage drop on the winding of the relay 4, owing to which the relay 4 is cut out and consequently the relay-actuated contact 5 is opened. The supply voltage is thereby withdrawn from the heating elements 7a, 7b.

The third and last possibility for breaking the electric circuit arises when the first pole 1a is disconnected from the direct-current voltage source, so that the voltage is withdrawn from the whole circuit. This condition exists, for example, when the ignition in the motor vehicle is turned off.

In each of the three possibilities described above for breaking the electric circuit according to the invention, the circuit can only be activated again by the selector switch 2, 3 being brought back into its first position 3b.

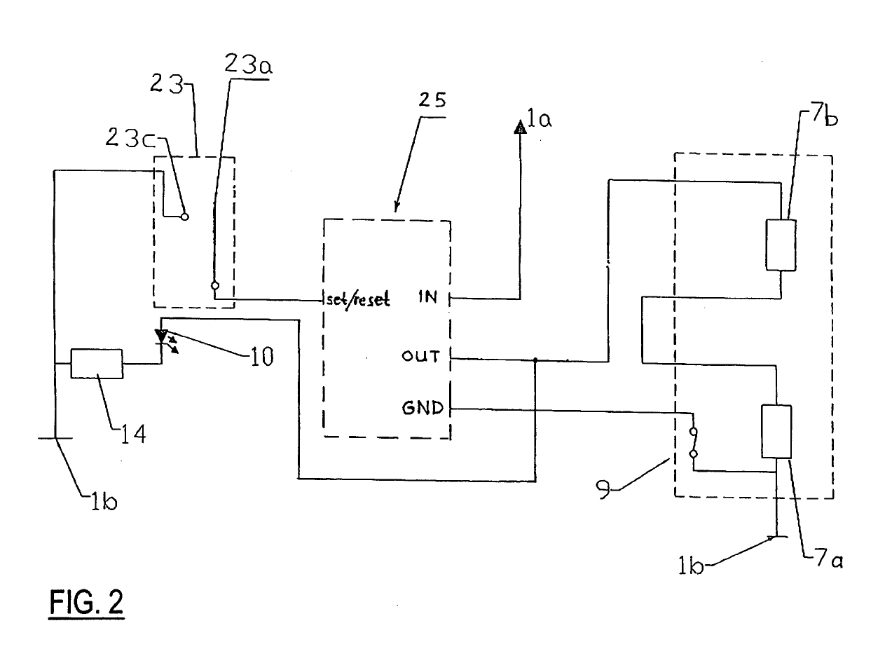

FIG. 2 shows an additional embodiment of the present invention in which, alternatively to the embodiment represented in FIG. 1, a double-pole relay 25 is used instead of the single-pole relay 4. The double-pole relay 25 has its own current supply (not shown), owing to which there is no longer any necessity for a current supply provided by the circuits of the switch components in the exemplary embodiment described above. The double-pole relay 25, for switching on or off, receives a switching pulse through connection of an automatic resetting selector switch 12 into its non-fixable switching position, as a result of which, instead of three switching positions, only one neutral position 23a and one non-fixable pulse-triggering switching position 23c is required.

The switching pulse received from the selector switch 23 causes, in the double-pole relay 25, the “OUT” connection of the relay 25 to be acted on by the voltage fed in by the first pole 1a via the “IN” port. In a next switching operation of the selector switch 23, the relay 25 receives an additional switching pulse, which interrupts the voltage supply of the “OUT” connection of the relay 25.

The two heating elements 7a, 7b, connected in series, are connected between the relay output “OUT” and the second pole 1b of the voltage source, while the second pole of the voltage source 1b is connected by the thermal switch 9 to the “GND” connection of the double-pole relay 25. Now, if the thermal switch 9, owing to heating up by the heating element 7a, reaches a predetermined temperature, it switches into an open state, so that the relay 25 is electrically separated from the second pole 1b of the voltage source. This causes opening of a contact, located in the relay 25 and not shown, between the “IN” and “OUT” connections of the double-pole relay 25.

In this embodiment, too, a light-emitting diode 10 is electrically coupled via a resistance 14 to a connection of the heating elements 7a, 7b, owing to which the turned-on state of the electric circuit is made known visually.

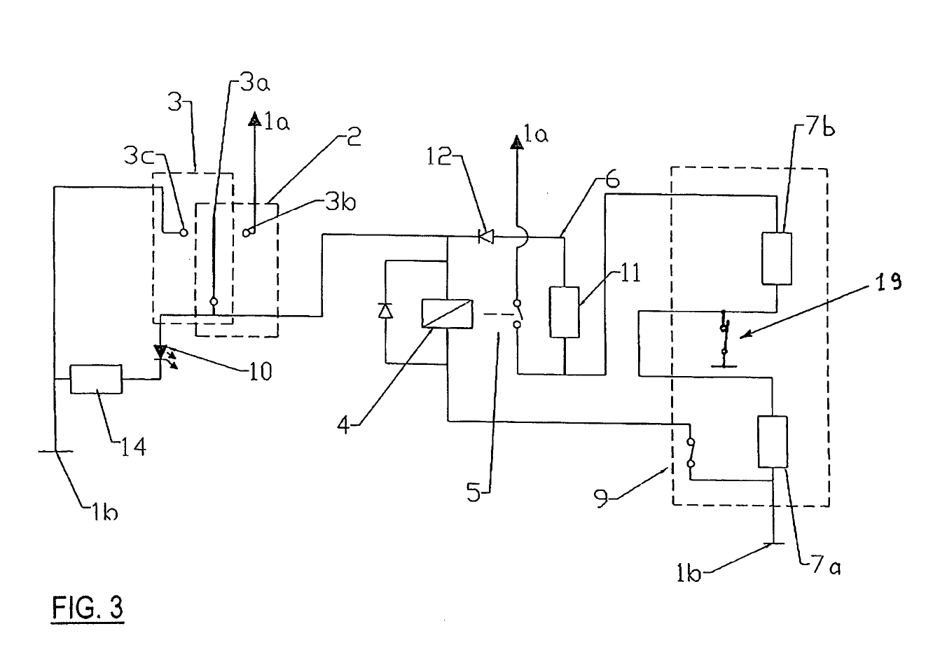

FIG. 3 shows an additional embodiment of the circuit according to the invention, which differs from the circuit shown in FIG. 1 in that an additional thermal switch 19 is provided between the two heating elements 7a and 7b. The second thermal switch 19 is connected to the two heating elements 7a, 7b, connected in series, on the one hand, and to the second pole 1b of the voltage source, on the other. In this embodiment, the first thermal switch 9 is assigned to the first heating element 7a, while the second thermal switch 19 is in thermal contact with the second heating element 7b. The second heating element 7b may provide seat heating in an automobile seat, while the first heating element 7a is provided for heating the backrest of the automobile seat.

Operation of the circuit arrangement represented in FIG. 3 proceeds as follows. Both thermal switches 9 and 19 are closed in an initial state at ambient temperature. After the heating system is turned on via the selector switches 2, 3, a heating current I₁ flows through the second heating element 7b corresponding to the seat heating, since the second heating element 7b is connected with the ground via the second thermal switch 19. In this case the heating power of the second heating element 7b amounts to P₁. The first heating element 7a, assigned to the backrest of the seat, remains turned off. After a predetermined temperature of the seat heating has been reached, the second thermal switch 19 opens. After the second thermal switch 19 has opened, a current I₂ flows through both heating elements 7a, 7b, I₂ being smaller than I₁. In this case, the heating power of the second heating element 7b is smaller than P₁. In the case of like resistances of the heating elements 7a and 7b, I₂=½I₁ and P₂=¼P₁.

After the second thermal switch 19 has been opened, operation of the circuit according to the invention continues as presented for the circuit shown in FIG. 1.

This embodiment makes it possible to supply the second heating element 7b or seat-heating element with higher heating power P₁ for a short time, so that the seat surface, which feels colder to the user due to greater pressure and thinner clothing between person and seat surface, is heated more rapidly than the backrest.

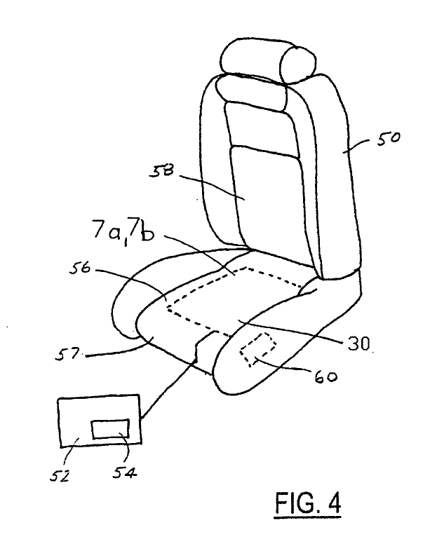

FIG. 4 shows a perspective and block diagrammatic view of a vehicle seat 50 incorporating an electrical circuit according to an embodiment of the present invention. The electrical circuit is electrically coupled to a controller 52 and a power supply 1a as described in more detail above. In this example, electrical power is transferred to the heating elements 7a, 7b to warm an upper surface 56 of the seat cushion 57 of the seat 50. Of course, as described above with reference to FIG. 3, the second heating element 7b could also be incorporated into the backrest 58 to similarly warm that portion of the seat 50 as well. As shown, the heating element 7a, 7b is contained within a seat cover 30 and is beneath and near the upper surface 56 to provide efficient transfer of thermal energy from the heating element to the upper surface 56. The heating element could also be incorporated into other portions of the seat cushion, and the seat system 50 could also include a fan or blower 60 electrically coupled to the controller 52 for directing air across the heating element towards the upper surface 56. A similar arrangement could also be included in the backrest 58. The heating element can also be integrated in the upholstery of the seat. In this case, the heating element is arranged on a core pad. The core pad is generally of foam material. The core pad can be either cast or foam. The heating element can be covered with an intermediate padding, a so-called “foam backing” arranged over the intermediate padding, and a covering material 30. The covering material 30 is usually fabric or leather, and may be perforated to aid in conveying air toward, or away from, the passenger. A heating element so arranged will heat surfaces in contact with a user rapidly and with low energy outlay.

While the invention has been described in connection with one or more embodiments, it is to be understood that the specific mechanisms and techniques which have been described are merely illustrative of the principles of the invention, numerous modifications may be made to the apparatus described without departing from the spirit and scope of the invention as defined by the appended claims.

What is claimed is:

1. Electric circuit for wiring at least one heating element, comprising:
a voltage source delivering a supply voltage;
at least one heating element;
a selector switch having at least one neutral position and at least one non-fixable switching position;
at least one relay having a relay-actuated contact that is open when the relay is disconnected from the supply voltage and which is closed when the relay is acted on by the supply voltage, where when the contact is closed, the heating element is acted on by the supply voltage; and
a first thermal switch in communication with the heating element and which opens upon reaching a predetermined temperature,
wherein the relay and at least one thermal switch are connected in series, and wherein setting the selector switch to the first non-fixable switching position causes the relay to change the switching status of the contact from open to closed or closed to open.

2. An electric circuit according to claim 1, wherein the relay is a single-pole relay, and wherein, when the contact is closed, the relay is acted on by the supply voltage, in the first switching position of the selector switch the relay is acted on by the supply voltage, and in the second switching position of the selector switch the relay is disconnected from the supply voltage to open the switching status of the contact.

3. An electric circuit according to claim 1, wherein the relay is a double-pole relay.

4. An electric circuit according to claim 1, wherein the voltage source, in the second switching position of the selector switch, is short-circuited by a first resistance.

5. An electric circuit according to claim 2, wherein the voltage source, in the second switching position of the selector switch, is short-circuited by a first resistance.

6. An electric circuit according to claim 2, wherein the voltage source is a direct-current voltage source having a first pole and a second pole,
the relay has an input and an output,
the at least one heating element comprises two heating elements, connected in series, have a first and a second connection, where the first connection, via the contact is connected to the first pole of the direct-current voltage source and the second connection is connected to the second pole of the direct-current voltage source,
the thermal switch is connected between the output of the relay and the second pole of the direct-current voltage source,
where in the first switching position of the selector switch the input of the relay is electrically connected with the first pole of the direct-current voltage source, and in the second switching position of the selector switch the input of the relay is electrically connected with the second pole of the direct-current voltage source, and
where the first connection of the heating elements is electrically connected with the input of the relay.

7. An electric circuit according to claim 6, wherein the relay is a double-pole relay.

8. An electric circuit according to claim 6, comprising a diode connected between the input of the relay and the first connection of the heating elements wherein, by the diode, in the first switching position of the selector switch, a voltage is obtained in the direction of the heating elements.

9. An electric circuit according to claim 6, wherein the input of the relay is connected by a light-emitting diode to the second pole of the direct-current voltage source.

10. An electric circuit according to claim 7, wherein the input of the relay is connected by a light-emitting diode to the second pole of the direct-current voltage source.

11. An electric circuit according to claim 1, wherein the selector switch is an automatically resetting selector switch.

12. An electric circuit according to claim 6, wherein the selector switch is an automatically resetting selector switch.

13. An electric circuit according to claim 1, comprising two heating elements and a second thermal switch, wherein the first thermal switch is in electrical communication with a first heating element and the second thermal switch is in electrical communication with a second heating element, and wherein the first and the second thermal switches switch at different temperatures.

14. An electric circuit according to claim 13, wherein the second thermal switch has at least one first switching position in which the first flow of heat travels through the two heating elements, connected in series, and at least one second switching position in which substantially all of the potential of the supply voltage is applied to the second heating element.

15. An electric circuit according to claim 14, wherein the second thermal switch is connected in parallel with the first heating element, and wherein in its first switching position it is open and in its second switching position is closed.

16. An electric circuit according to claim 3, wherein the relay comprises:
an input (IN) for feed of the supply voltage from a first pole of the voltage source;
a first connection to the selector switch, whose switching into a non-fixable switching position causes change of the switching status of a contact located in the relay;
an output (OUT) for action on the heating element by the supply voltage; and
a second connection connected by the at least one thermal switch to a second pole of the voltage source.

17. A vehicle seat system comprising:
a seat cushion having a core pad;
at least one heating element;
a selector switch having at least one neutral position and at least one non-fixable switching position;
at least one relay having a relay-actuated contact that is open when the relay is disconnected from a supply voltage and which is closed when the relay is acted on by the supply voltage, where when the contact is closed, the heating element is acted on by the supply voltage;
a first thermal switch in communication with the heating element and which opens upon reaching a predetermined temperature; and
a seat cover overlaying the heating element and coupling the heating element to the core pad,
wherein the relay and at least one thermal switch are connected in series, and wherein setting the selector switch to the first non-fixable switching position causes the relay to change the switching status of the contact from open to closed or closed to open.

18. A vehicle seat system according to claim 17, comprising two heating elements and a second thermal switch, wherein the first thermal switch is in electrical communication with a first heating element and the second thermal switch is in electrical communication with a second heating element.

19. A vehicle seat system according to claim 18, wherein one of the heating elements is associated with a seat cushion and the other heating element is associated with a backrest cushion of the vehicle seat.

20. A vehicle seat system according to claim 19, wherein the second thermal switch has at least one first switching position in which the first flow of heat travels through the two heating elements, connected in series, and at least one second switching position in which substantially all of the potential of the supply voltage is applied to the second heating element.
